(19) United States
(12) Patent Application Publication
(10) Pub. No.: US 2004/0184902 A1
(43) Pub. Date: Sep. 23, 2004

(54) Refuse cart lifter with an improved range of operation

(76) Inventors: Billy K. Bayne, Simpsonville, SC (US); William T. Smothers, Simpsonville, SC (US); Jimmy M. Biggerstaff, Paulinc, SC (US)

Correspondence Address: MCANDREWS HELD & MALLOY, LTD, 500 WEST MADISON STREET, SUITE 3400, CHICAGO, IL, 60661

(21) Appl. No.: 10/803,281

(22) Filed: Mar. 18, 2004

Related U.S. Application Data
(60) Provisional application No. 60/455,546, filed on Mar. 18, 2003.

(51) Int. Cl. B65F 3/02

(52) U.S. Cl. 414/408

(57) ABSTRACT

A lifter is disclosed which allows for an improved operating envelope of the faceplate. The lifter utilizes a motor having 210 degrees of rotation and lifting arms of a unique geometry to rotate a faceplate from a retracted position below and substantially behind the lifter baseplate to a dumping position above and substantially behind a lower hopper edge for the purpose of dumping refuse carts into a refuse collection vehicle. This dumps refuse further into the vehicle hopper, which minimizes the number of packing cycles required on a collection route. A faceplate is attached to the motor using two lifting arms. The faceplate has a fixed upper hook and a sliding, retractable lower hooking mechanism. This sliding hook feature makes the lifter more compact when retracted and improves ground clearance when the lifter is mounted on the rear of a rear-loading refuse collection vehicle. Longer lifting arms may be substituted to allow for use of the lifter with a side-loading refuse collection vehicle.

### RELATED APPLICATIONS

This application makes reference to, claims priority to, and claims the benefit of U.S. Provisional Patent Application Serial No. 60/455,546, entitled “Refuse Collection Cart Lifter With An Improved Range Of Rotation” (Attorney Docket 14893US01), filed Mar. 18, 2003, the complete subject matter of which is hereby incorporated herein by reference in its entirety.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The present invention relates to refuse container lifting devices, and in particular to refuse cart lifting devices. Refuse containers are often quite heavy, and therefore refuse collection vehicles are generally equipped with refuse container lifting devices to assist the vehicle operator when emptying the refuse containers. However, a refuse collection vehicle may encounter several different types of refuse containers on a given collection route, and the differences in these refuse containers often require the use of separate lifting devices. For example, large commercial refuse containers, or dumpsters, are typically emptied by tipping the container over the edge of the vehicle hopper using a variety of lifting devices, including tipper bars and cable and winch arrangements.

Refuse carts are relatively light refuse receptacles constructed from various plastics and other synthetic materials. Features of refuse carts may include for example hinged covers, locking covers, wheels, and handles in various locations and configurations. Capacities generally range for example from 30 gallons to 95 gallons. Refuse carts typically encountered in residential areas are emptied using a refuse cart lifter capable of engaging the refuse cart, lifting it, and inverting the refuse cart to empty refuse into the vehicle hopper.

Many prior refuse cart lifters presented a wide profile and thus protrude from the refuse collection vehicle so as to interfere with the emptying of commercial dumpsters when they are tipped over the edge of the vehicle hopper. Protruding cart lifters also created a hazard for the rear-loading refuse collection vehicle driver when backing up, and the side-loading refuse collection driver when navigating narrow roadways, such as alleys. Some lifter designs have addressed this problem by locating the lifter off to the side of or even completely beneath the refuse collection vehicle hopper. Others attempted to reduce the profile of the refuse cart lifter to address the lifter protrusion issue.

Another problem in the refuse cart lifter industry is that cart lifters typically hang down from the refuse collection vehicle, and therefore reduce the vehicle's ground clearance, particularly on uneven ground. Thus, some lifter designs include a retracted position where the lifter is angled underneath the refuse collection vehicle hopper, rather than hanging straight down.

Yet another issue involves refuse compaction cycles. Prior cart lifters continuously dump refuse into the portion of the vehicle hopper closest to the refuse cart lifter because these lifters cannot empty the refuse cart a substantial distance into the hopper when dumping. The refuse therefore quickly accumulates near the refuse cart lifter, which requires the vehicle operator to stop collecting carts and compact the refuse to prevent interference with the next lifter dumping cycle. Thus, a lifter that empties refuse carts further into the refuse collection vehicle hopper would decrease the amount of time and energy spent compacting refuse between refuse cart dumping.

A final issue involves maintenance of the lifter. Elevated hydraulic loads associated with some lifters correspond to increased wear and strain on cart lifter systems. Also, some lifter motor designs are readily susceptible to damage from contaminants present in the hydraulic system and eventually require complex repairs or rebuilding that can typically only be performed at the manufacturer's facility. Finally, many lifters use bearings that require regular greasing.

Thus, a need exists in the refuse collection industry for a residential refuse cart lifter that possesses a slim profile, provides improved ground clearance, decreases the amount of time and energy spent compacting refuse between the emptying of successive refuse carts, provides needed lifting capacity at lower hydraulic pressures, requires little maintenance, and is easy to repair or rebuild at the end user's facility.

### SUMMARY OF THE INVENTION

The present invention relates to a refuse cart lifter that allows for an improved operating envelope of the lifter faceplate. The improved operating envelope results from a wide range of rotation of the lifter faceplate in combination with a unique lifter arm design. This yields a refuse cart lifter that is capable of being retracted when not in use for increased ground clearance, while dumping refuse further into the refuse collection vehicle hopper than prior lifters. This added dumping range increases the efficiency of refuse collection because a vehicle operator does not have to operate the vehicle's packing blade as frequently, resulting in savings in time and energy.

The presently preferred version of the refuse cart lifter utilizes a motor to rotate a lifting arm and faceplate 210 degrees for the purpose of dumping refuse containers into a receptacle. It is preferable to use a dual rack and single pinion hydraulically actuated unit as the motor due to its thin profile and superior lifting capacity at lower hydraulic pressures. This motor design also is preferable due to its open gear design, which makes it less susceptible to damage from contaminants in the hydraulic fluid system, and for the ease with which the lifter can be repaired or rebuilt at the end users facility. This actuator is based on the same design disclosed in U.S. Pat. No. 4,773,812, which is hereby incorporated by reference.

The faceplate is attached to the motor using two lifting arms having a unique design that is capable of directing the faceplate substantially into the vehicle hopper when used with a motor having a wide range of rotation. The faceplate has one fixed saddle and one retractable lower hooking mechanism, or sliding latch. This allows the lifter to be more compact in its home (retracted) position and improves ground clearance when mounted on the rear of a rear loaded refuse collection vehicle. The sliding latch feature is based on the design that is disclosed in U.S. Pat. No. 5,308,211 and related patents, which are hereby incorporated by reference.

Other design features include the use of composite bearing materials in exposed bearing areas, such as the bearings that form a part of the sliding latch guide, to make the unit more maintenance free by eliminating the need for regular greasing. Also, longer lifting and latch arms may be utilized to allow for mounting the lifter on the side of a side-loading refuse collection vehicle.

The present lifter faceplate extends partially underneath the refuse collection vehicle in the retracted position, and therefore does not protrude significantly outward of the refuse cart lifter motor. The slim profile of the lifter motor and the retracted position of the faceplate function to preclude interference with the dumping of large commercial containers over the lifter. Thin bumpers may also be mounted to the vehicle to protect the lifter as large commercial containers are dumped into the hopper.

To empty a residential refuse cart into the hopper of the refuse collection vehicle, the lifter commences an emptying cycle. During the emptying cycle, the lifter motor rotates the lifter faceplate from a retracted position partially beneath the vehicle such that a fixed saddle engages the refuse cart. As the lifter continues to rotate, the cart is lifted in a sweeping arc motion towards the hopper. Meanwhile, a sliding latch gradually engages a lower lifting point on the refuse cart to prevent the loss of the cart into the hopper as the cart is emptied. To prevent unwanted movements of the sliding latch during operation, a sliding latch guide can be incorporated, which includes bearings to reduce friction while sliding. At the end of the emptying cycle, the cart is positioned significantly inward of the outer hopper edge.

An unloading cycle reverses the emptying cycle and the cart is brought back down to street level in a sweeping arc motion. As the cart descends, the sliding latch gradually disengages the lower lifting point on the refuse cart, followed by the disengagement of the upper saddle and upper lifting point on the refuse cart after the cart reaches the ground. The lifter can then be rotated further until the faceplate returns to the retracted position, substantially under the refuse collection vehicle.

### BRIEF DESCRIPTION OF SEVERAL VIEWS OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an exemplary refuse cart lifter in accordance with the present invention shown in a retracted position;

FIG. 2 is a perspective view of an exemplary refuse cart lifter in accordance with the present invention shown in an intermediate position;

FIG. 3 is a perspective view of an exemplary refuse cart lifter in accordance with the present invention shown in a dumping position;

FIG. 4 is a side view of an exemplary refuse cart lifter in accordance with the present invention shown in a retracted position;

FIG. 5 is a side view of an exemplary refuse cart lifter in accordance with the present invention shown in an intermediate position;

FIG. 6 is a side view of an exemplary refuse cart lifter in accordance with the present invention shown in a dumping position;

FIG. 7 is a front view of an exemplary refuse cart lifter in accordance with the present invention shown in a retracted position;

FIG. 8 is a front view of an exemplary refuse cart lifter in accordance with the present invention shown in a dumping position;

FIG. 9 is a side view of an exemplary refuse cart adjacent to a refuse cart lifter in accordance with the present invention shown in a retracted position;

FIG. 10 is a side view of an exemplary refuse cart lifter in accordance with the present invention shown engaging the upper lifting point of an adjacent refuse cart;

FIG. 11 is a side view of an exemplary refuse cart lifter in accordance with the present invention shown in a dumping position engaging the upper and lower lifting points of a refuse cart;

FIG. 12 is a perspective view of an exemplary refuse cart adjacent to a refuse cart lifter in accordance with the present invention shown in a retracted position;

FIG. 13 is a perspective view of an exemplary refuse cart lifter in accordance with the present invention shown engaging the upper lifting point of an adjacent refuse cart;

FIG. 14 is a perspective view of an exemplary refuse cart lifter in accordance with the present invention shown in a dumping position engaging the upper and lower lifting points of a refuse cart;

FIG. 15 is a front view of the rear of a rear-loading refuse collection vehicle showing two lifters in accordance with the present invention mounted to the rear of the refuse collection vehicle;

FIG. 16 is a side view of an exemplary refuse cart lifter in accordance with the present invention shown in a retracted position and mounted on a rear-loading refuse collection vehicle;

FIG. 17 is a partially cut away side view of an exemplary refuse cart lifter in accordance with the present invention shown in a dumping position and mounted on a rear-loading refuse collection vehicle;

### DETAILED DESCRIPTION OF THE INVENTION

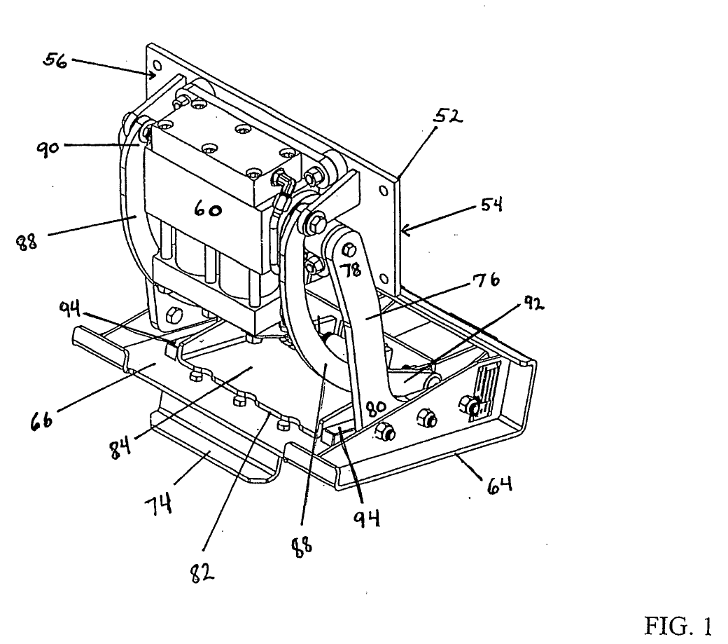

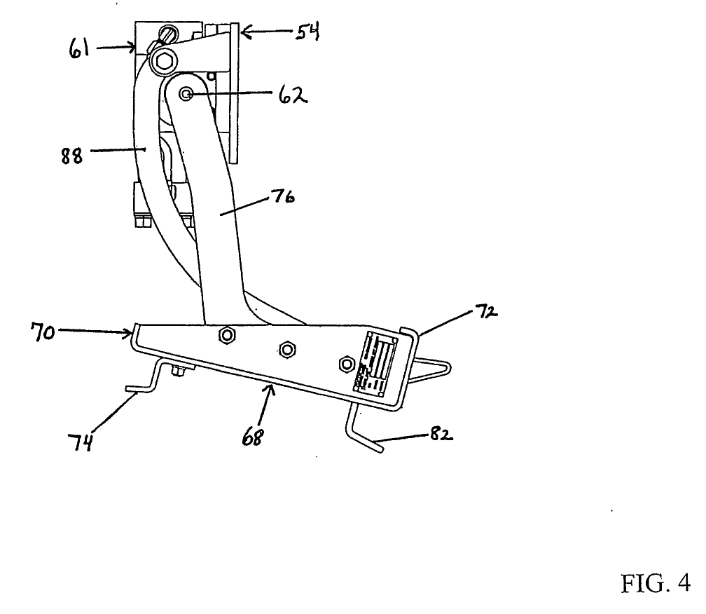

FIG. 1 depicts a preferred embodiment of the present refuse cart lifter shown in a retracted position. The motor 60 is affixed to the front side 56 of the baseplate 52. The motor depicted is a dual rack, single pinion hydraulic actuator capable of 210 degrees of rotation. The rear side 54 of baseplate 52 can be attached to a refuse collection vehicle or a large refuse collection container. Dual lifting arms 76 are attached at a first end 78 of the lifting arms 76 to the rotatable shaft 62 (see FIG. 4) of motor 60. The second end 80 of the lifting arms 76 are attached to the faceplate 64. In this view, the inner surface 66 of faceplate 64 is clearly visible, as is the saddle 74.

The inner surface 84 of a portion of the sliding latch 82 is also seen. The sliding latch 82 is connected to the baseplate 52 with dual latch arms 88. A first end 90 of the latch arms 88 is pivotally connected to the front side 56 of baseplate 52. A second end 92 of the latch arms 88 is pivotally connected to the sliding latch 82. A pair of sliding latch guides 94 which limit undesirable sliding latch 82 movement in relation to faceplate 64 is also depicted.

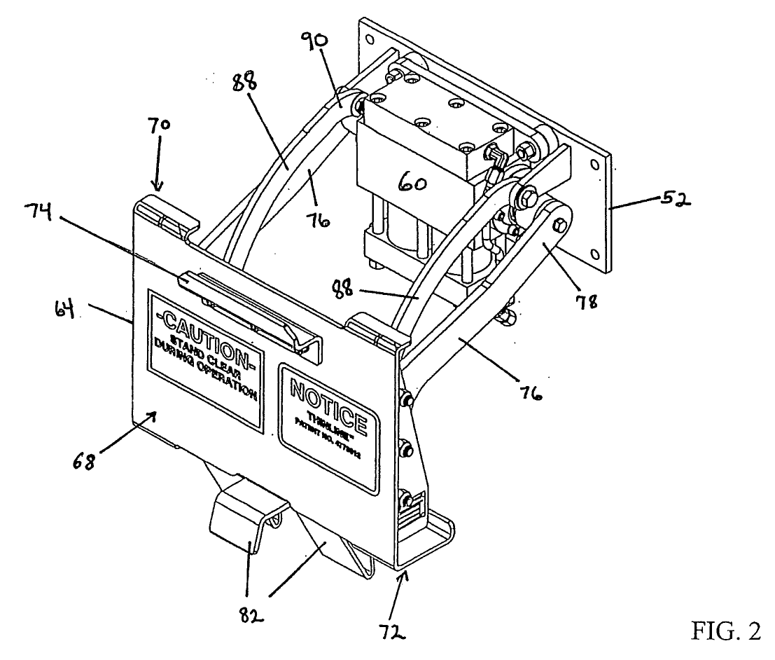

FIG. 2 depicts a preferred embodiment of the present refuse cart lifter shown in an intermediate position. In this figure, the motor 60 has rotated the lifting arms 76 and swung faceplate 64 to a position essentially parallel to baseplate 52. Note that latch arms 88 have also swung upwards with the sliding latch 82, which has yet to slide significantly in relation to faceplate 64 to a point where it would engage a refuse cart due to the geometry of the lifting arms 76 in relation to the latch arms 88. Also shown in this figure is the location of the upper end 70 and the lower end 72 of faceplate 64.

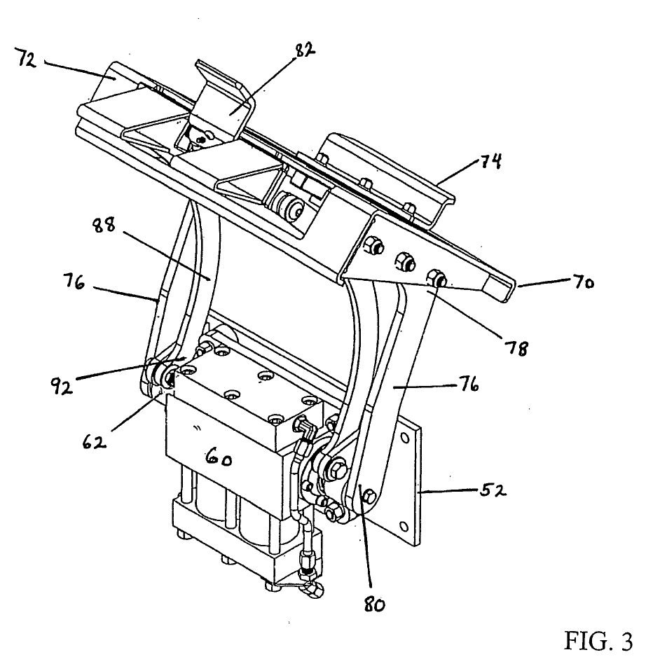

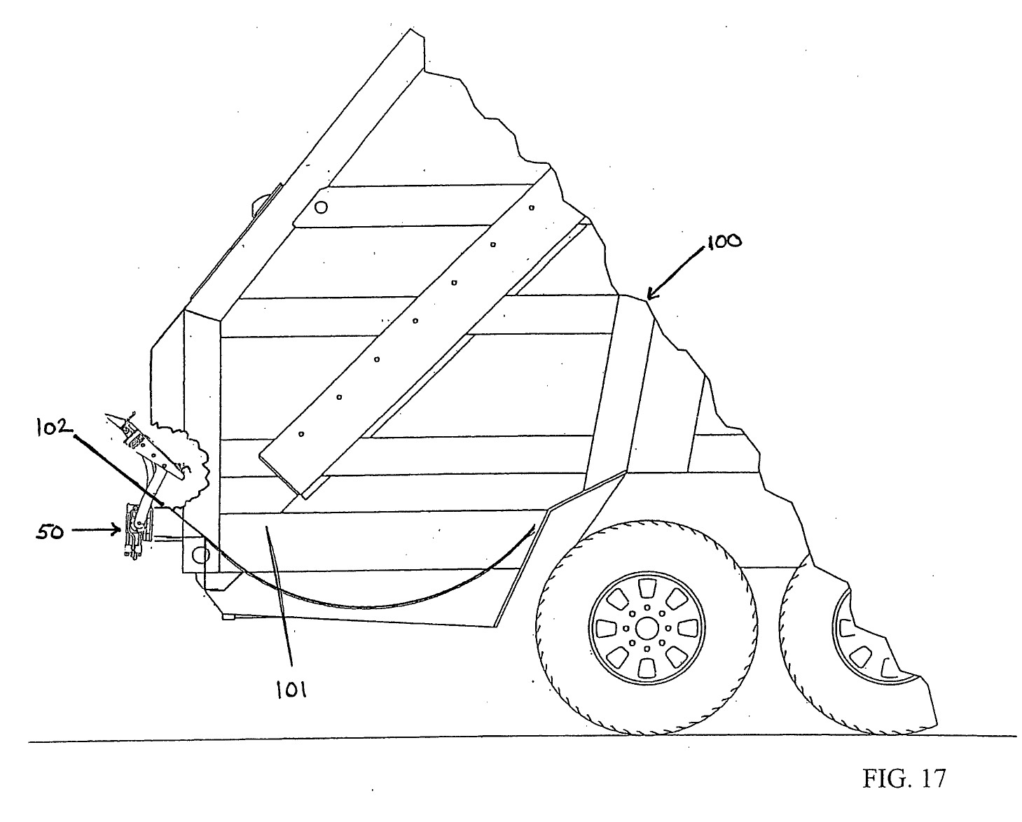

FIG. 3 depicts a preferred embodiment of the present refuse cart lifter shown in a dumping position, which is the extreme opposite of the retracted position depicted in FIG. 1. In FIG. 3, the motor 60 has further rotated rotatable shaft 62 and attached lifting arms 76 past a vertical position. The resulting angle of the first end 78 of lifting arms 76 away from the back side 54 of the baseplate 52 (or towards the hopper if the lifter is mounted on a refuse collection vehicle—see FIG. 17), combined with the design of the lifting arms 76 that directs the second end 80 of lifting arms 76 even further away from the back side 54 of the baseplate 52 serves to swing faceplate 64 to a position above and substantially behind baseplate 52. Lifting arm 76 design directs the second end 80 of lifting arms 76 away from the back side 54 of the baseplate 52 by offsetting the second end 80 of lifting arm 76 from the lifting arm using, for example, a curve or an angle in lifting arm 76. This wide range of rotation of motor 60 and unique geometry of lifting arms 76 facilitates the dumping of refuse further into the refuse receptacle or refuse collection vehicle hopper than otherwise possible using existing lifters.

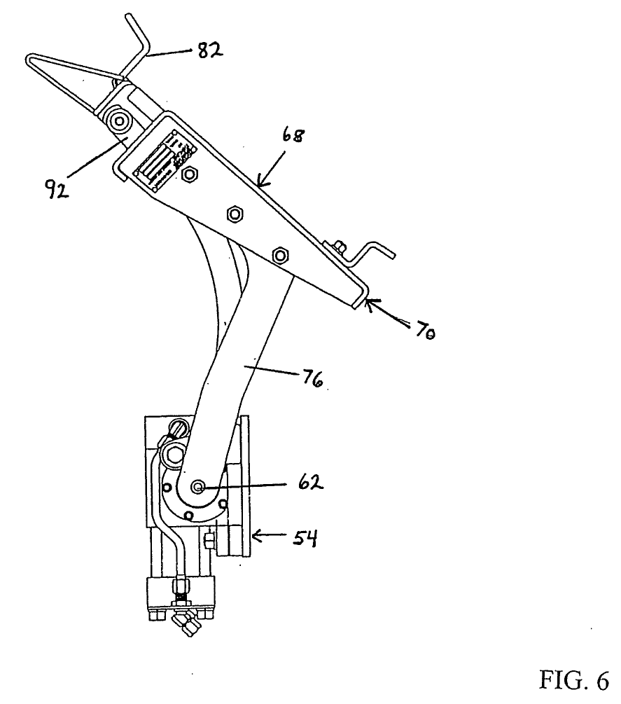

Latch arms 88 have also swung upwards with the sliding latch 82. Although better seen in FIG. 6, the first ends. 90 of latch arms 88 are pivotally attached to the front side 56 of baseplate 52, while the second ends 92 of latch arms 88 are pivotally attached to sliding latch 82. Latch arms 88 are of a length and geometry calculated to cause the sliding latch 82 to engage the refuse cart at some point after faceplate 64 moves from the intermediate position depicted in FIG. 2 to the dumping position. A sliding latch guide 94 prevents undesirable movements of the sliding latch, and includes bearings to reduce the sliding friction resulting from the movement of sliding latch 82. The point at which sliding latch 82 begins to slide away from the lower end 72 of faceplate 64 can be adjusted by varying either the location of the pivotal connection of the latch arms 88 to the front side 56 of the baseplate 52, or the length and geometry of the latch arms 88 themselves, or both.

FIGS. 4 through 6 depict a side view of a preferred embodiment of the present refuse cart lifter shown in the retracted, intermediate and dumping positions, respectively, but this time from a side view. FIG. 4 shows one end of rotatable shaft 62. In addition, this figure shows that the lower end 72 of faceplate 64 is located below and substantially behind baseplate 52 when the lifter is in the retracted position. The unique geometry of the lifting arms 76 and the latch arms 88 can also be seen. Note the effect of the lift arm 76 geometry as the lift arms 76 are rotated the full 210 degrees to the dumping position in FIG. 6. Also important is the slim profile depicted in this retracted configuration, showing the faceplate 64, lifting arms 76, and latch arms 66 located substantially behind the outermost face 61 of motor 60. This facilitates the emptying of large commercial refuse containers over the refuse cart lifter, thereby enhancing the versatility of the refuse collection vehicle.

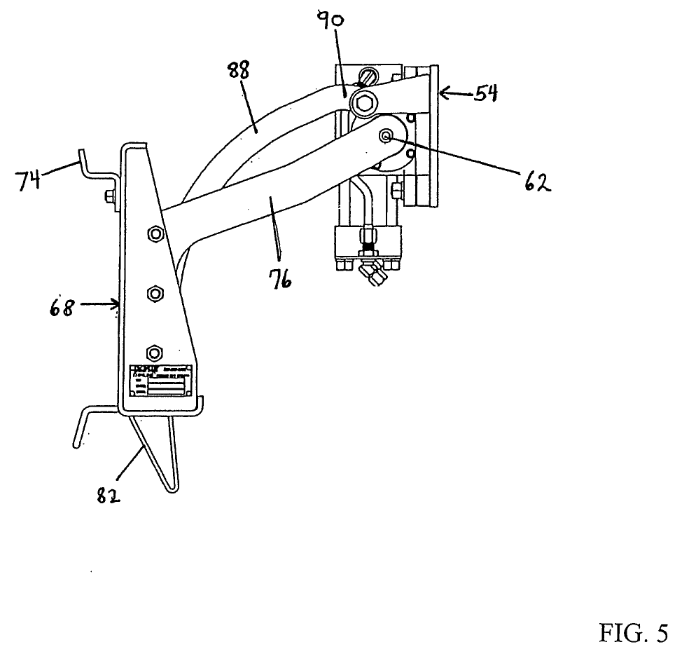

FIG. 5 depicts a side view of the preferred embodiment of the present refuse cart lifter in an intermediate position. As in FIG. 2, the faceplate 64 is essentially parallel to baseplate 52. At this point, the movement of the latch arms 88 has not yet caused sliding latch 82 to engage the refuse cart.

FIG. 6 depicts a side view of the preferred embodiment of the present refuse cart lifter in the dumping position. Here it can be observed that the relative connection points and geometries of lifting arms 76 and latch arms 88 have caused sliding latch 82 to slide away from the lower end 72 of faceplate 64 as the faceplate 64 moved from the intermediate position shown in FIG. 5 to the dumping position. As discussed in reference to FIG. 3, the unique geometry of the lifting arms 76 coupled with 210 degrees of lifting arm 76 rotation from the retracted position serve to position the upper end 70 of faceplate 64 above and substantially behind baseplate 52. This facilitates the dumping of refuse further into the receiving refuse container than otherwise possible with conventional lifters.

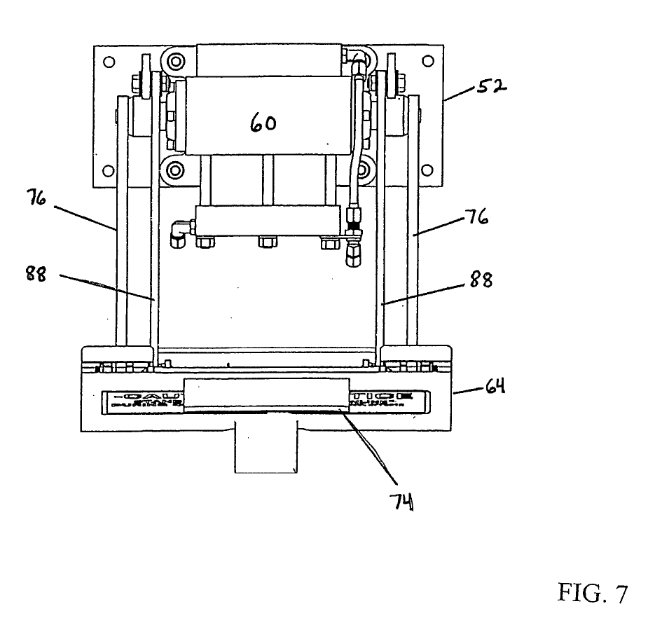

FIG. 7 depicts a front view of the preferred embodiment of the present refuse cart lifter in the retracted position. This view shows the vertical relation of faceplate 64 to the baseplate 52, with faceplate 64 positioned well beneath baseplate 52.

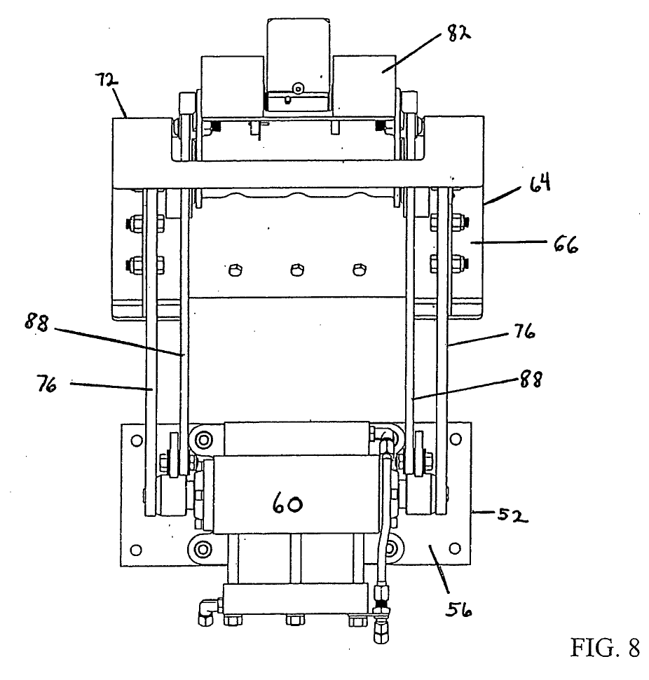

FIG. 8 depicts a front view of the preferred embodiment of the present refuse cart lifter in the dumping position. This view shows the sliding latch 82 extended out from the lower end 72 of faceplate 64, and faceplate 64 positioned above baseplate 52.

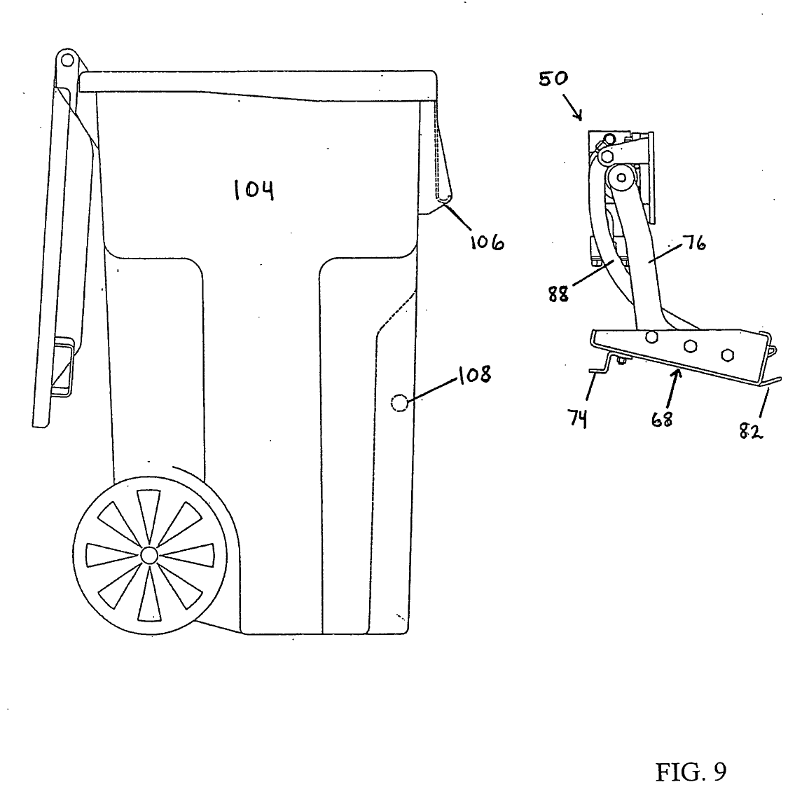

FIGS. 9 through 11 show a side view of the emptying of a refuse cart using a preferred embodiment of the present refuse cart lifter 50. Initially, an operator would position a refuse cart 104 adjacent to an embodiment of the present refuse cart lifter 50, as depicted in FIG. 9 (showing a side view of a preferred embodiment of the present refuse cart lifter 50 in the retracted position). The upper lifting point 106 and lower lifting point 108 of refuse cart 104 are also illustrated.

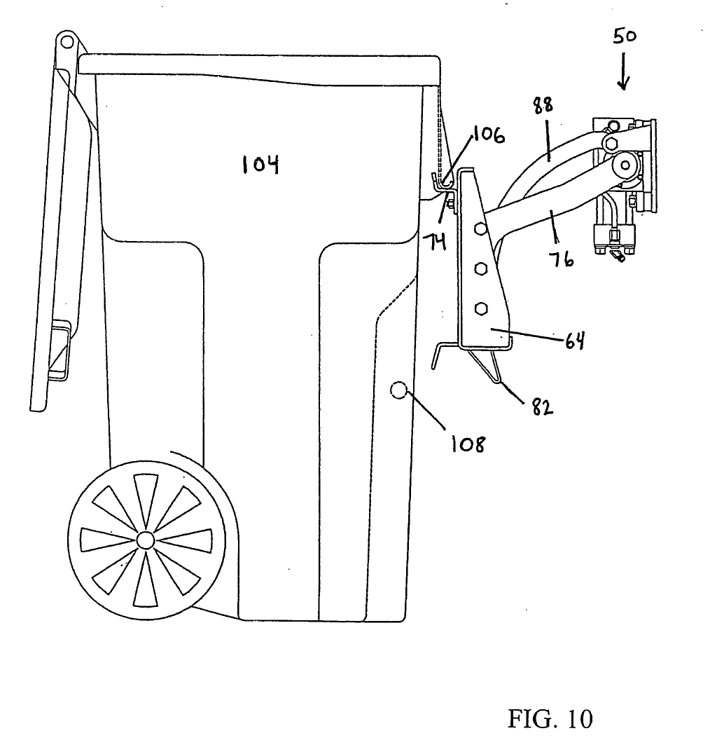

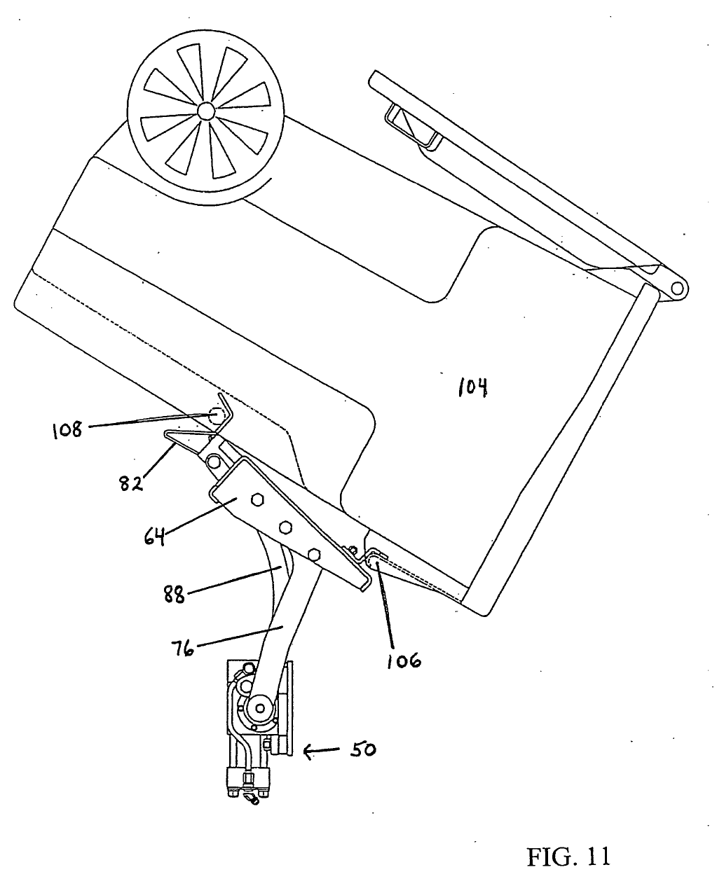

Once refuse cart 104 is positioned adjacent to refuse cart lifter 50, refuse cart lifter 50 would be operated to rotate lifting arms 76 to swing faceplate 64 up such that saddle 74 engages refuse cart upper lifting point 106 as seen in FIG. 10. The continued operation of the lifter then causes the upper end 70 of faceplate 64 to swing over and substantially behind baseplate 52, thereby dumping refuse from the refuse cart far behind baseplate 52 as shown in FIG. 11. In addition, while faceplate 64 is swinging from the intermediate position depicted in FIG. 10 to the emptying position shown here in FIG. 11, the relative geometries of lifting arms 76 and latch arms 88 cause sliding latch 82 to slide out and away from lower end 72 of faceplate 64 and engage refuse cart lower lifting point 108. This prevents refuse cart 104 from falling into the refuse collection area when saddle 74 is inverted as seen in FIG. 11.

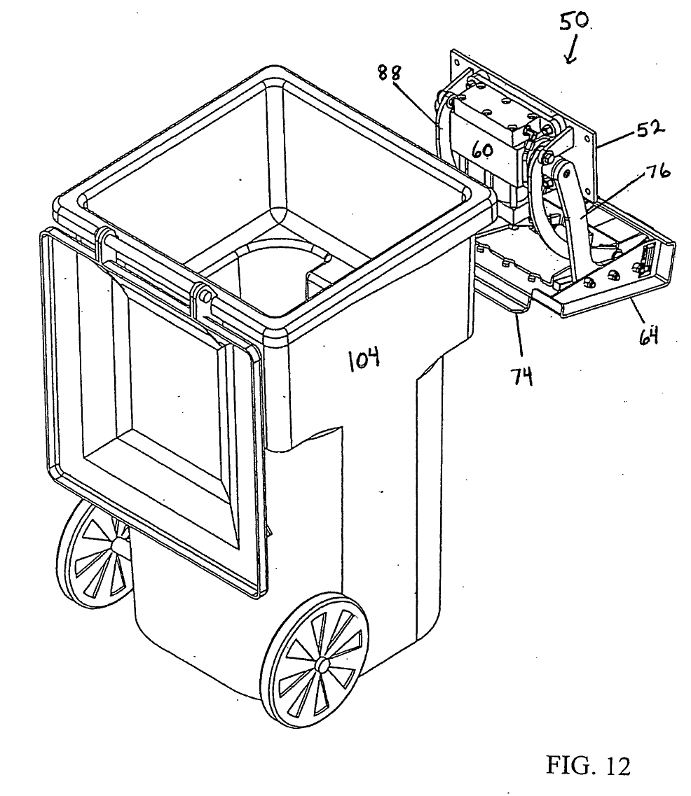

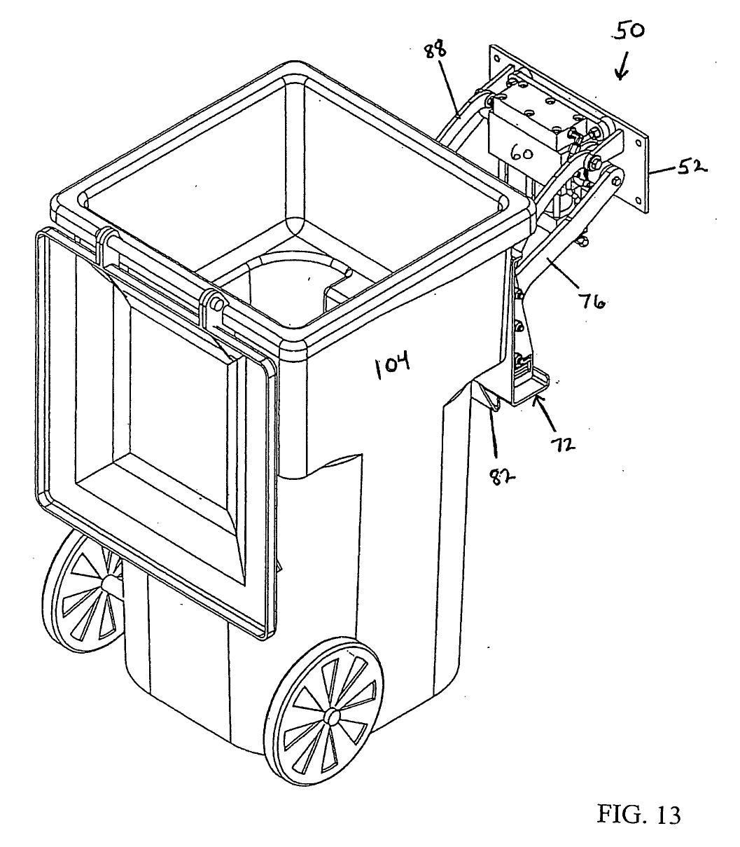

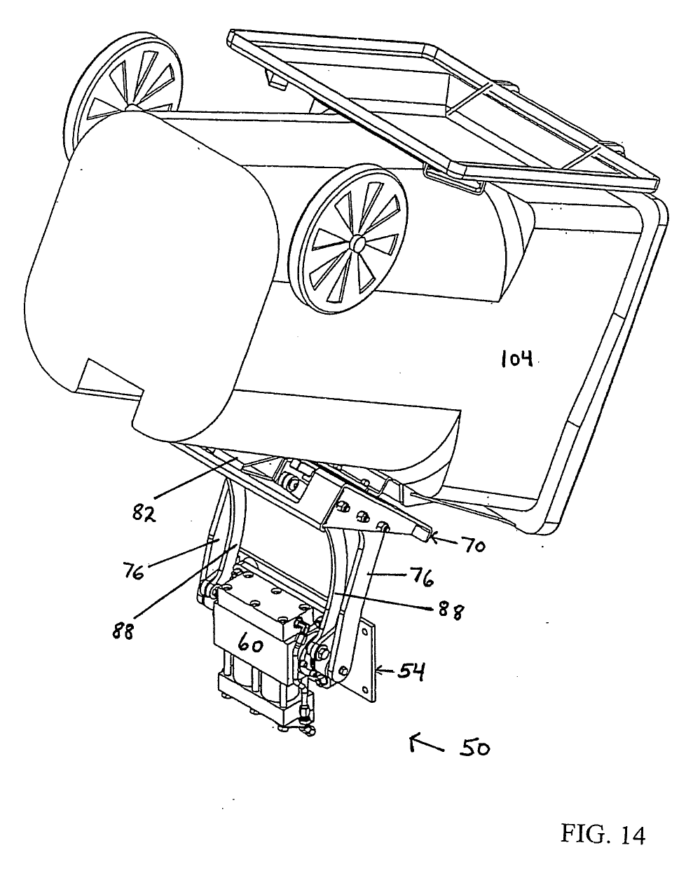

FIGS. 12 through 14 depict the same sequence of events as FIGS. 9 through 11 during the emptying of refuse container 104, but from a perspective view. A preferred embodiment of the present refuse cart lifter 50 is shown in a retracted position adjacent to refuse cart 104 in FIG. 12. FIG. 13 depicts the refuse cart lifter 50 engaging refuse cart upper lifting point 106 after lifting arms 76 have swung faceplate 64 up and away from baseplate 52. Finally, FIG. 14 shows the refuse cart lifter 50 faceplate 64 swung to the dumping position with both saddle 74 and sliding latch 82 engaging refuse cart 104 at lifting points 106 and 108, respectively.

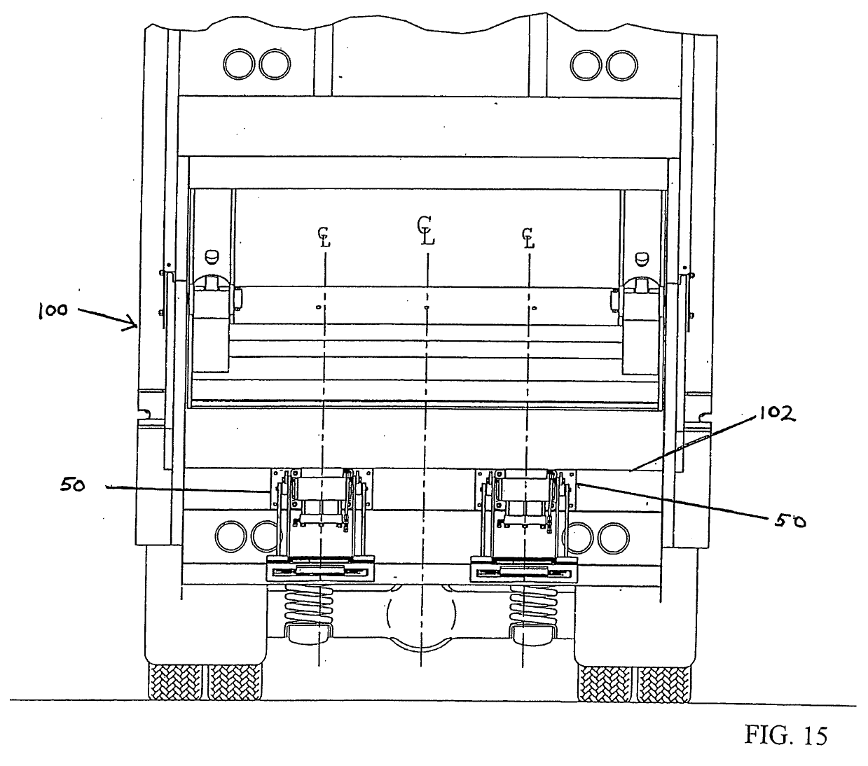

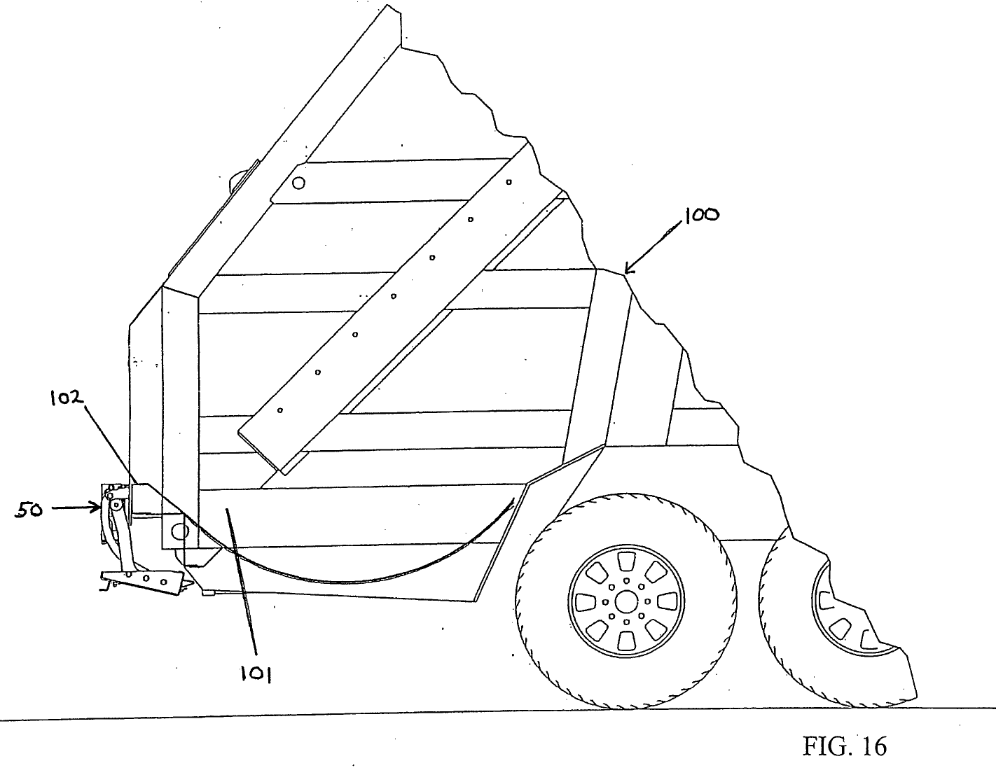

FIG. 15 depicts dual lifters 50 mounted to a refuse collection vehicle 100. The refuse hopper 101 is shown, as is lower hopper edge 102. As discussed previously, when refuse cart lifters 50 are operated to empty a refuse cart 104, lifting arms 76 will cause faceplate 64 to swing over and substantially inward of lower hopper edge 102. This can be seen by examining FIGS. 16 and 17, which depict a refuse cart lifter 50 mounted on a rear-loading refuse collection vehicle 100.

FIG. 16 depicts a preferred embodiment of the present refuse cart lifter 50 shown in a retracted position and attached to a refuse collection vehicle 100. This figure emphasizes the slim side profile of the lifter, which facilitates the dumping of large commercial containers over the refuse cart lifter 50 when in the retracted position. FIG. 17 depicts the refuse cart lifter 50 in a the dumping position, and offers a cutaway view (represented by jagged lines) of the refuse collection vehicle hopper showing the upper end 70 of faceplate 64 angled over the baseplate 52 and extending substantially inward of lower hopper edge 102. An embodiment of the present refuse cart lifter could also be readily mounted to a side-loading refuse collection vehicle (not shown).

The words used above are words of description rather than of limitation. Although preferred embodiments of the invention have been described using specific terms, devices, and methods, such description is for illustrative purposes only. It should be understood that aspects of the various embodiments may be interchanged both in whole or in part. Therefore, the spirit and scope of the appended claims should not be limited to the description of the preferred versions contained therein.

For example, a refuse cart lifter in accordance with this invention could utilize a single lifting arm or a single latch arm, or various multiples of each or both. Furthermore, the lifter could be mounted to freestanding refuse containers, intermediate containers, rear-loading refuse collection vehicles, or side-loading refuse collection vehicles. Thus, it should be understood that changes and variations may be made by those of ordinary skill in the art without departing from the spirit or the scope of the present invention, which is set forth in the following claims.

What is claimed is:

1. A refuse cart lifting device comprising:
a baseplate having a front side and a back side;
a motor attached to the front side of the baseplate, the motor having a rotatable shaft;
a faceplate, the faceplate having an outer surface and an inner surface, the faceplate also having an upper and a lower end;
a saddle fixedly attached to the outer surface of the faceplate;
at least one lifting arm having a first end and a second end, the first end of the at least one lifting arm attached to the rotatable shaft, the second end of the at least one lifting arm attached to the faceplate;
a sliding latch, the sliding latch having an inner and outer surface, the outer surface in sliding proximity with the inner surface of the faceplate;
at least one latch arm, the at least one latch arm having a first end and a second end, the first end of the at least one latch arm pivotally connected to the front side of the baseplate, and the second end of the at least one latch arm pivotally attached to the sliding latch; and
the lower end of the faceplate is capable of being retracted below and substantially behind the baseplate when the refuse cart lifting device is not in use, and the upper end of the faceplate is capable of being rotated above and substantially behind the baseplate when the lifting device is emptying a refuse cart.

2. The refuse cart lifting device of claim 1, where the at least one lifting arm is connected to the inner surface of the faceplate.

3. The refuse cart lifting device of claim 1, further comprising a sliding latch guide attached to the inner surface of the faceplate, the sliding latch guide in sliding proximity with the sliding latch.

4. The refuse cart lifting device of claim 1, where the motor is capable of rotating the rotatable shaft at least 210 degrees.

5. The refuse cart lifting device of claim 1, where the at least one lifting arm is shaped to direct the faceplate above and substantially behind the baseplate when the lifter is emptying a refuse cart.

6. A refuse collection vehicle, the refuse collection vehicle including a refuse hopper for the collection of trash, the refuse hopper having a lower hopper edge over which refuse containers are emptied into the refuse hopper, the refuse collection vehicle further including a refuse cart lifting device, the refuse cart lifting device comprising:
a baseplate attached to the refuse collection vehicle below and adjacent to the hopper edge, the baseplate having a front side facing away from the refuse collection vehicle and a back side facing the refuse collection vehicle;
a motor attached to the front side of the baseplate, the motor having a rotatable shaft;
a faceplate, the faceplate having an outer surface and an inner surface, the faceplate also having an upper end and a lower end;
a saddle fixedly attached to the outer surface of the faceplate;
at least one lifting arm having a first end and a second end, the first end of the at least one lifting arm attached to the rotatable shaft, the second end of the at least one lifting arm attached to the faceplate;
a sliding latch, the sliding latch having an inner and outer surface, the outer surface in sliding proximity with the inner surface of the faceplate;
at least one latch arm, the at least one latch arm having a first end and a second end, the first end of the at least one latch arm pivotally connected to the front side of the baseplate, and the second end of the at least one latch arm pivotally attached to the sliding latch; and
the lower end of the faceplate is capable of being retracted below and substantially behind the baseplate when the refuse cart lifting device is not in use, and the upper end of the faceplate is capable of being rotated above and substantially inward of the lower hopper edge when the lifting device is emptying a refuse cart.

7. The refuse collection vehicle of claim 6, where the refuse collection vehicle is a rear-loading vehicle.

8. The refuse collection vehicle of claim 6, where the refuse collection vehicle is a side-loading vehicle.

9. The refuse cart lifting device of claim 6, further comprising a sliding latch guide attached to the inner surface of the faceplate, the sliding latch guide in sliding proximity with the sliding latch.

10. The refuse collection vehicle of claim 6, where the at least one lifting arm is shaped to direct the faceplate above and substantially inward of the lower hopper edge when the lifting device is emptying a refuse cart.

11. A method for emptying refuse carts having a first and second lifting point into a refuse collection vehicle with a refuse cart lifter, the refuse collection vehicle including a refuse hopper for the collection of trash, the refuse hopper having a lower hopper edge over which refuse containers are emptied into the refuse hopper, the method comprising:
operating the refuse cart lifter from a retracted position below and substantially inward of the lower hopper edge to a position where the refuse cart lifter engages the first lifting point refuse cart;
further operating the refuse cart lifter to lift the refuse cart up and towards the refuse collection vehicle and causing the refuse cart lifter to engage the second lifting point of the refuse cart; and
operating the refuse cart lifter still further to empty refuse from the refuse cart into the refuse hopper at a location substantially inward of the lower hopper edge.

12. The method for emptying refuse carts into a refuse collection vehicle of claim 11, where the hopper edge is located along a side of the refuse collection vehicle.

13. The method for emptying refuse carts into a refuse collection vehicle of claim 11, where the hopper edge is located along the rear of the refuse collection vehicle.

14. The method for emptying refuse carts into a refuse collection vehicle of claim 11, further comprising operating a motor to rotate at least one lifting arm, a faceplate containing a saddle, at least one latch arm, and a sliding latch in sliding proximity to the faceplate.

15. The method for emptying refuse carts into a refuse collection vehicle of claim 14, further comprising a sliding latch guide attached to the faceplate in sliding proximity to the sliding latch.
